(19) United States
(12) Patent Application Publication
(10) Pub. No.: US 2008/0028014 A1
(43) Pub. Date: Jan. 31, 2008

(54) N-BIT 2's COMPLEMENT SYMMETRIC ROUNDING METHOD AND LOGIC FOR IMPLEMENTING THE SAME

(76) Inventors: Jason W. HILT, Tucson, AZ (US); David J. BAKER, Tucson, AZ (US)

Correspondence Address: Renner, Otto, Boisselle & Sklar, 19th Floor, 1621 Euclid Ave., Cleveland, OH, 44115, US

(21) Appl. No.: 11/459,993

(22) Filed: Jul. 26, 2006

(51) Int. Cl. G06F 7/38

(52) U.S. Cl. 708/497

(57) ABSTRACT

A rounding circuit is provided that includes an input for receiving a 2's complement number to be rounded. The 2's complement number has a format SXY, where S represents a sign bit, X represents one or more bits to round and keep, and Y represents one or more bits to be discarded. The rounding circuit also includes first logic for adding a rounding bias to the 2's complement number, and second logic for at least one of subtracting the sign bit S from the 2's complement number, or adding the inverted sign bit !S to the 2's complement number. Moreover, the rounding circuit includes third logic for truncating Y bits from a result produced by the first and second logic to produce a rounded 2's complement number having a format SX.

### TECHNICAL FIELD

The present invention relates generally to a method and circuitry for performing rounding in the 2's complement numbering system. More particularly, the present invention relates to a space efficient and high throughput method and circuitry for symmetric rounding of N-bit 2's complement numbers.

### BACKGROUND OF THE INVENTION

Digital circuits for carrying out arithmetic operations are well known. For example, computer programs and hardware typically have a limit on the size or precision of numbers which may be processed therein. Rounding is a term used to describe how to reduce the size of numbers processed within the digital circuits in order to remain within such limit.

For example, rounding is used to reduce the number of bits stored in a fixed point or floating point arithmetic result, e.g., a multiplication result or an addition sum. The specific reduction of the number of bits may be dictated by the physical constraints of the hardware that carries out the arithmetic operation, the desired fidelity, and/or the desired precision of the arithmetic result.

A scientific, logical, repeatable, determinative method of rounding is required to be able to best anticipate a correct result. Many different rounding methods are known. For example, one familiar method involves biasing the rounding result positive by 0.5 (commonly referred to as “rounding up”). Another method is to bias the result negative by 0.5 (commonly referred to as “rounding down”). Rounding away from the origin and rounding toward the origin are other examples of biased rounding. Simply truncating the unneeded bits to the right of the desired result is the simplest method of rounding. All of these methods introduce error into the result with simple truncation degrading the result the most.

Rounding a 2's complement data representation away from the origin is more complicated than rounding a sign/magnitude representation away from the origin. Since digital circuits typically carry out arithmetic operations using a 2's complement numbering system, complicated rounding operations can detrimentally affect the space requirements and/or throughput speed. According to conventional rounding methods, digital logic for performing the rounding operations must have large space requirements in order to provide high speed throughput. Alternatively, the digital logic may have smaller space requirements but at the expense of throughput speed.

In view of the aforementioned shortcomings associated with rounding techniques for numbers in a 2's complement numbering system, there is a strong need in the art for a rounding method and logic that is space efficient and provides high throughput. Specifically, there is a strong need in the art for a rounding method that requires minimum logic and time to execute.

### SUMMARY OF THE INVENTION

According to one aspect of the present invention, a rounding circuit for performing rounding of a 2's complement number is provided. The rounding circuit includes an input for receiving the 2's complement number to be rounded, the 2's complement number having a format SXY, where S represents a sign bit, X represents one or more bits to round and keep, and Y represents one or more bits to be discarded. In addition, the rounding circuit includes first logic for adding a rounding bias to the 2's complement number, and second logic for at least one of subtracting the sign bit S from the 2's complement number, or adding the inverted sign bit !S to the 2's complement number. Moreover, the rounding circuit includes third logic for truncating Y bits from a result produced by the first and second logic to produce a rounded 2's complement number having a format SX.

According to another aspect of the invention, a method for performing rounding of a 2's complement number is provided. The method includes the steps of receiving the 2's complement number to be rounded, the 2's complement number having a format SXY, where S represents a sign bit, X represents one or more bits to round and keep, and Y represents one or more bits to be discarded; adding a rounding bias to the 2's complement number; at least one of subtracting the sign bit S from the 2's complement number, or adding the inverted sign bit !S to the 2's complement number; and truncating Y bits from a result produced by the first and second logic to produce a rounded 2's complement number having a format SX.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of a logic circuit for rounding an N-bit 2's complement number in accordance with an embodiment of the present invention;

FIG. 2 is a block diagram of a logic circuit for rounding an N-bit 2's complement number in accordance with another embodiment of the present invention;

FIG. 3 is a block diagram of a logic circuit for rounding an N-bit 2's complement number in accordance with another embodiment of the present invention;

FIG. 4 is a block diagram of a logic circuit for rounding an N-bit 2's complement number in accordance with another embodiment of the present invention;

FIG. 5 is a block diagram of a logic circuit for rounding an N-bit 2's complement number in accordance with another embodiment of the present invention;

FIG. 6 is a flowchart representing the operation of the logic circuits in the embodiments of FIGS. 1-3 in accordance with the present invention;

FIG. 7 is a flowchart representing the operation of the logic circuits in the embodiments of FIGS. 4-5 in accordance with the present invention; and

FIG. 8 is a block diagram of an arithmetic logic unit incorporating a rounding logic circuit in accordance with the present invention.

### DETAILED DESCRIPTION OF THE INVENTION

The present invention will now be described with reference to the figures, wherein like reference labels are used to refer to like elements throughout.

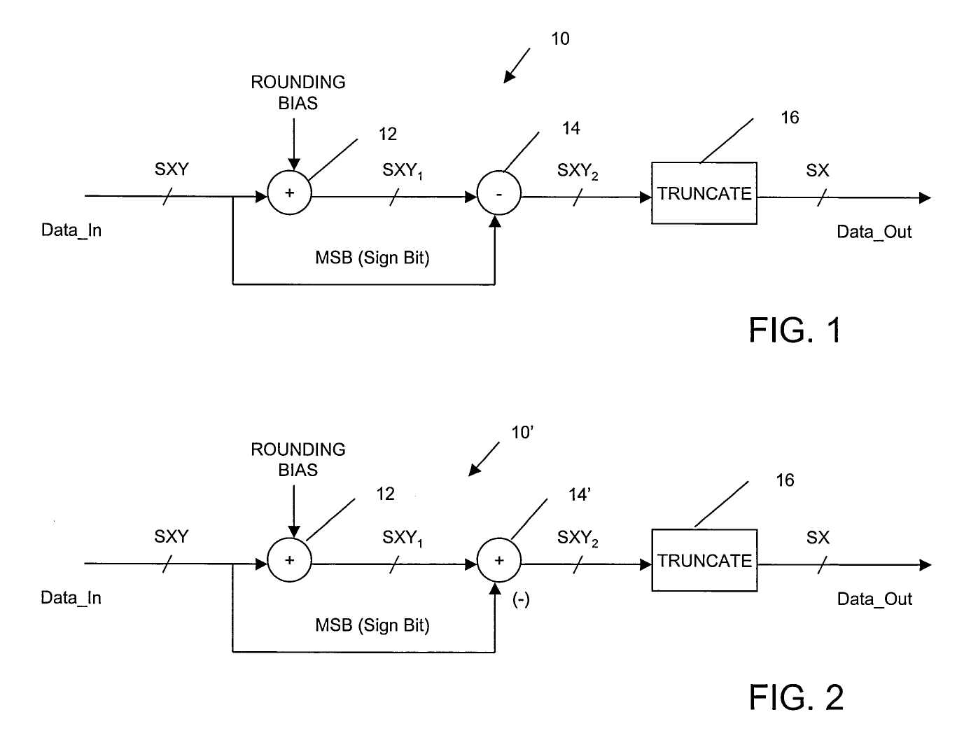

Referring initially to FIG. 1, an example of a logic circuit 10 for rounding 2's complement numbers in accordance with the present invention is shown. The logic circuit 10, like the other embodiments of the invention described herein, takes advantage of the properties of signed 2's complement numbers to yield a unique method of performing rounding without requiring combinatorial logic on the input data to yield the resultant data.

As will be appreciated in view of the following discussion of FIG. 1 and the other embodiments described herein, the rounding method and logic of the present invention accomplishes symmetric 2's complement rounding of N-bit data more efficiently than conventional designs. The logic may be implemented according to conventional techniques using hardware description languages (HDLs), discrete logic, programmable logic such as field-programmable gate arrays (FGPAs), or any other type of design tools or logic circuitry.

The rounding method implemented by the logic circuit 10 of FIG. 1 and the other embodiments described herein helps to minimize error sources within a system by reducing rounding errors. This in turn provides, for example, additional margin to a design error budget, as well as a reduction in the number of bits required to be stored for a fixed-point or floating point arithmetic result. The improved performance of the rounding circuitry leads to improved overall system performance, particularly in high-performance designs.

The invention may be implemented in a space efficient and high throughput manner. The invention is particularly useful in any environment where many instances of rounding are required. For example, the logic circuit 10 may be utilized in radar applications in front end pre-processing pipelines where many instances of rounding are required potentially after every multiply, complex multiply, FIR filter, digital down conversion, pulse compression, etc. In another example, the logic circuit 10 may be implemented in fast Fourier transform (FFT) engines, digital video processors, etc. Other uses include in mobile telephones, digital video recorders, DVD players/recorders, personal digital assistants, wrist watches, calculators, computer graphics, GPS receivers, hardware simulators, or virtually any application in which digital math is performed.

For ease of explanation, the input data to be rounded is N-bit data represented by a format SXY. “S” denotes the leftmost or most significant bit (MSB), and represents the “sign bit” of the input data as is conventional. “X” represents the bit or bits following the sign bit which are to be rounded and kept as a result of the rounding. “Y” represents the bit or bits to the right of the X bit(s) that are to be truncated as a result of the rounding.

In accordance with the embodiment of FIG. 1, the input data (represented by “Data_In”) is input to the logic circuit 10 in the SXY format. The input data is input to an adder 12 included in the logic circuit 10. The adder 12 adds a preselected rounding bias to the input data SXY. This rounding bias is preselected by the designer and can be any value (e.g., such as the typical rounding bias of 0.5 (base₁₀)).

The output of the adder 12, represented by SXY₁, is input to a subtractor 14. The subtractor 14 serves to subtract the most significant bit of the input data, the sign bit S, from SXY₁. The subtractor 14 in turn outputs a result represented by SXY₂. The result SXY₂ is input to a truncator circuit 16 that functions to truncate the Y bit or bits from SXY₂ to produce the rounded result SX (represented by Data_Out).

### EXAMPLE 1

Using the logic circuit 10 of FIG. 1 in accordance with the present invention, assume the input data Data_in is in a 3.3 signed two's complement number format. The nomenclature “3.3” indicates 3 bits to the left of the decimal point, and 3 bits to the right as is conventional. Moreover, assume X is equal to 2, and Y is equal to 3 in the present example. The rounding bias is selected to be 0.5. The following Table 1 illustrates the rounding of the Data_in for six different values of data:

TABLE 1

| Data_In | Rounding | | | | Data_Out |
|---|---|---|---|---|---|
| SXY | Bias | Sign Bit | SXY₁ | SXY₂ | SX |
| 001010 | 000100 | 000000 | 001110 | 001110 | 001 |
| (1.25) | (0.5) | (0) | (1.75) | (1.75) | (1) |
| 001100 | 000100 | 000000 | 010000 | 010000 | 010 |
| (1.50) | (0.5) | (0) | (2.00) | (2.00) | (2) |
| 001110 | 000100 | 000000 | 010010 | 010010 | 010 |
| (1.75) | (0.5) | (0) | (2.25) | (2.25) | (2) |
| 110110 | 000100 | 000001 | 111010 | 111001 | 111 |
| (−1.25) | (0.5) | (0.125) | (−0.75) | (−0.875) | (−1) |
| 110100 | 000100 | 000001 | 111000 | 110111 | 110 |
| (−1.50) | (0.5) | (0.125) | (−1) | (−1.125) | (−2) |
| 110010 | 000100 | 000001 | 110110 | 110101 | 110 |
| (−1.75) | (0.5) | (0.125) | (−1.25) | (−1.375) | (−2) |

(Base 10)

FIG. 2 illustrates an alternative embodiment of the logic circuit in accordance with the present invention, designated 10′. The logic circuit 10′ is identical to the logic circuit in FIG. 1, with the exception that the subtractor 14 is replaced by an adder 14′ having a negative input. Consequently, the logic circuit 10′ produces the same net results as in the above Example 1 provided with respect to the embodiment of FIG. 1.

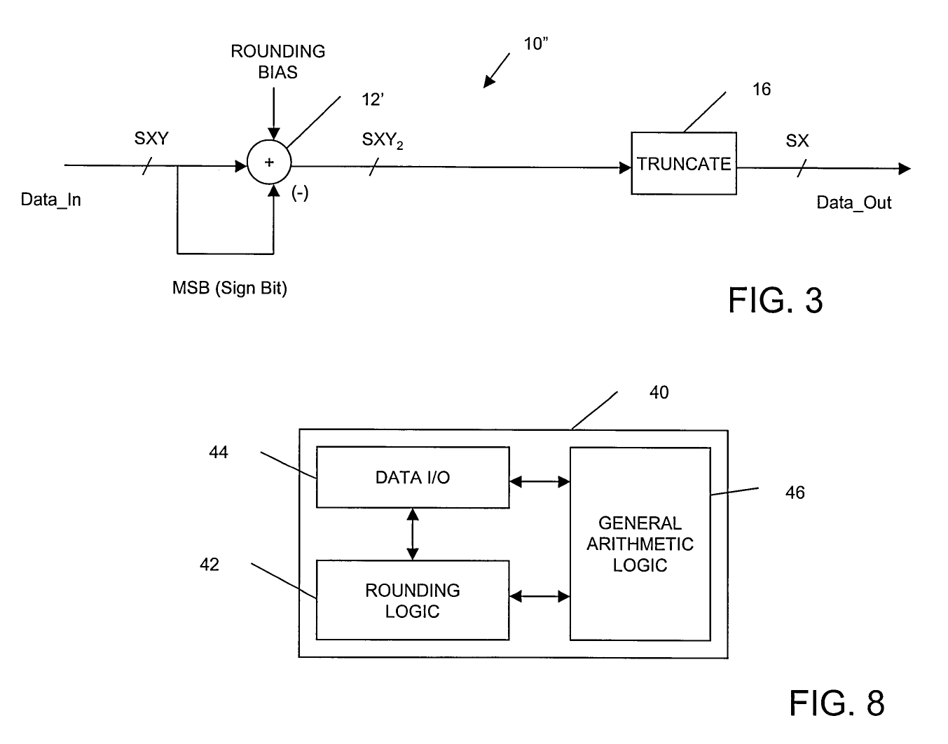

FIG. 3 represents yet another embodiment of the logic circuit, designated 10″. In this embodiment, a single three input adder 12′ with a negative input serves to add the rounding bias and subtract the Sign Bit from the input data Data_in. Again, the same net results shown in Table 1 above are obtained.

Although not shown, it will be appreciated that the adders 12 and 12′ in the above embodiments of FIGS. 1-3 may include sign extension capabilities to extend the sign bit. As is conventional, the sign bit may be extended to account for adder tree growth.

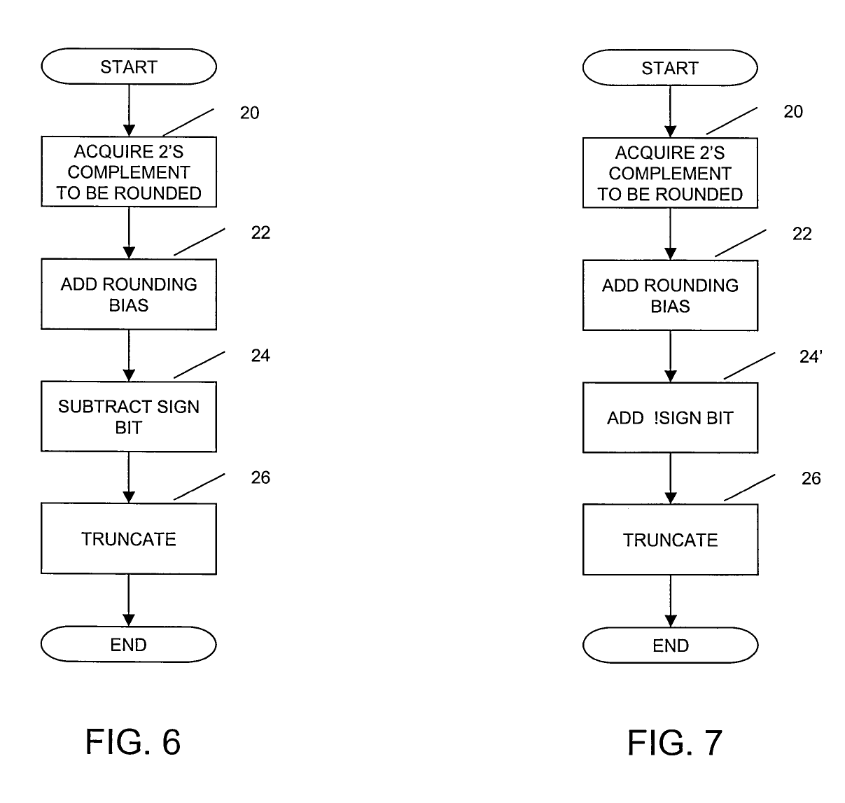

The rounding method carried out in the logic circuits of FIGS. 1-3 can be summarized by the flow chart illustrated in FIG. 6. Beginning in step 20, the logic circuit acquires the 2's complement number to be rounded (e.g., Data_In). Next, in step 22 the logic circuit adds the rounding bias value to the number to be rounded. In the above examples represented in Table 1, the rounding bias value is equal to 0.5, but it will be appreciated that any other rounding bias value could be used in the alternative. In step 24, the logic circuit subtracts the most significant bit of the number to be rounded, namely the sign bit, from the number to be rounded. Thereafter, the logic circuit in step 26 truncates the desired number of bits to result in the rounded 2's complement number.

Although step 22 is shown as preceding step 24 in FIG. 6, it will be appreciated that such steps may be carried out in reverse order or even simultaneously as represented in the embodiment of FIG. 3.

The logic circuits of FIGS. 1-3 illustrate a simple structure that is space efficient in it's implementation. Moreover, the structure lends itself well to pipeline processing as will be appreciated.

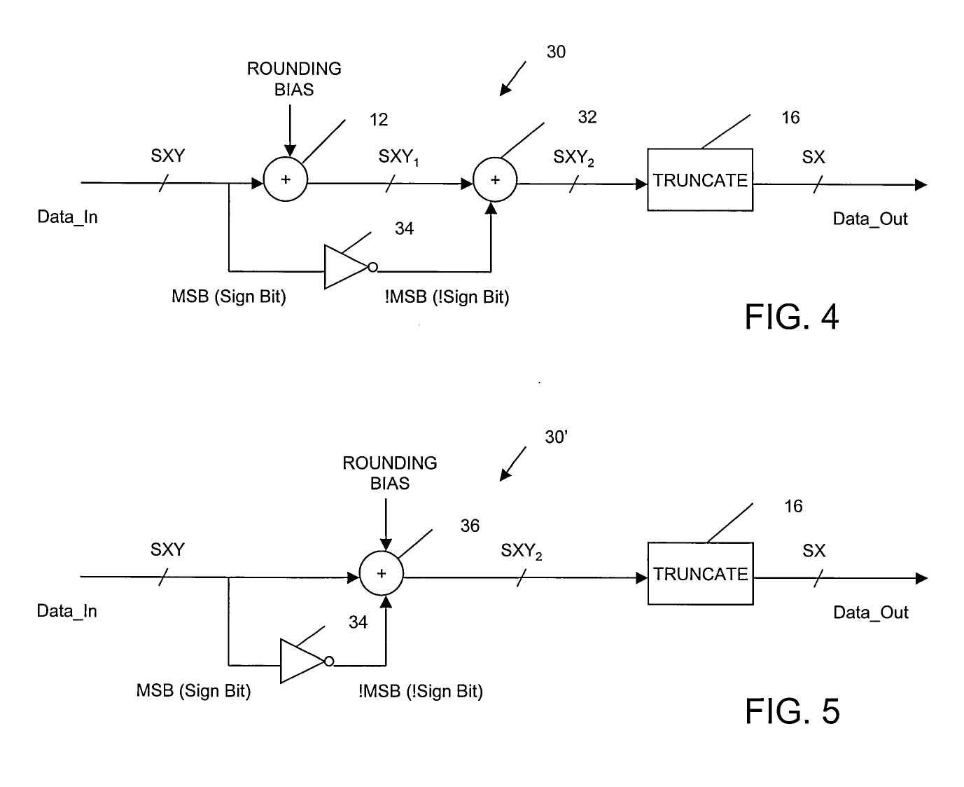

Referring now to FIG. 4, another embodiment of the present invention is illustrated. In this embodiment, a logic circuit 30 avoids the need to subtract the sign bit by instead simply adding the inverted sign bit. As will be appreciated by those skilled in the art, the logic required to make up a subtractor is more complex than the logic which makes up a simple adder.

Thus, the logic circuit 30 again includes an input for receiving the input data (represented by “Data_In”). As in the previous embodiments, the input data is assumed to be in the SXY format for ease of description. The input data again is input to an adder 12 included in the logic circuit 30. The adder 12 adds the preselected rounding bias to the input data SXY. Again, this rounding bias is preselected by the designer and can be any value (e.g., such as the typical rounding bias value of 0.5—one least significant bit (LSB) weight (base₁₀)).

The output of the adder 12, represented by SXY₁, is input to another adder 32. The adder 32 serves to add the inverted most significant bit of the input data, i.e., the inverted sign bit S, to SXY₁. (For ease of explanation, the inverted sign bit is represented by !MSB or !SignBit.) The inverted sign bit !SignBit is provided via an inverter 34 included in the logic circuit 30. The adder 32 in turn outputs a result represented by SXY₂. The result SXY₂ is again input to a truncator circuit 16 that functions to truncate the Y bit or bits from SXY₂ to produce the rounded result SX (represented by Data_Out).

### EXAMPLE 2

Using the logic circuit 30 of FIG. 4 in accordance with the present invention, again assume the input data Data_in is a 3.3 signed two's complement number. The nomenclature “3.3” indicates 3 bits to the left of the decimal point, and 3 bits to the right as is conventional. Moreover, assume X is equal to 2, and Y is equal to 3 in the present example. The rounding bias value is selected to be 0.375. The following Table 2 illustrates the rounding of the Data_in for six different values of data:

TABLE 2

| Data_In | Rounding | | | | Data_Out |
|---|---|---|---|---|---|
| SXY | Bias | !Sign Bit | SXY₁ | SXY₂ | SX |
| 001010 | 000011 | 000001 | 001101 | 001110 | 001 |
| (1.25) | (0.375) | (0.125) | (1.625) | (1.75) | (1) |
| 001100 | 000011 | 000001 | 001111 | 010000 | 010 |
| (1.50) | (0.375) | (0.125) | (1.875) | (2.00) | (2) |
| 001110 | 000011 | 000001 | 010001 | 010010 | 010 |
| (1.75) | (0.375) | (0.125) | (2.125) | (2.25) | (2) |
| 110110 | 000011 | 000000 | 111001 | 111001 | 111 |
| (−1.25) | (0.375) | (0) | (−0.875) | (−0.875) | (−1) |
| 110100 | 000011 | 000000 | 110111 | 110111 | 110 |
| (−1.50) | (0.375) | (0) | (−1.125) | (−1.125) | (−2) |
| 110010 | 000011 | 000000 | 110101 | 110101 | 110 |
| (−1.75) | (0.375) | (0) | (−1.375) | (−1.375) | (−2) |

(Base 10)

FIG. 5 illustrates an embodiment of the logic circuit 30′ in which the adders 12 and 32 are replaced by a three-input adder 36. As will be appreciated, the same net results as in the embodiment of FIG. 4 are achieved. Alternatively, in another embodiment the three-input adder 36 of FIG. 5 could be replaced with a two-input adder with a carry-in bit as will be appreciated.

As in the previous embodiments, it will be appreciated that the adders 12 and 36 in the embodiments of FIGS. 4-5 also may include sign extension capabilities to extend the sign bit. As is conventional, the sign bit may be extended to account for adder tree growth.

FIG. 7 is a flowchart illustrating the method carried out by the embodiments of FIGS. 4 and 5. Steps 20, 22 and 26 are the same as the embodiment illustrated in FIG. 6. The only difference is that instead of subtracting the sign bit as is done in step 24 in FIG. 6, the method of FIG. 7 adds the inverted sign bit as represented in step 24′. Again, steps 22 and 24′ may be carried out in reverse order or simultaneously without departing from the scope of the invention.

FIG. 8 represents an illustrative example where the rounding logic of the present invention can be implemented as part of an arithmetic logic unit (ALU) 40 or other processor in which it is desirable to round 2's complement numbers. The rounding logic 42 may be represented by any of the embodiments discussed above. Data is received via an input/output interface 44 or general arithmetic logic 46 included in the ALU 40.

Thus, it will be appreciated that the rounding method and logic of the present invention provides high-performance rounding with minimum space requirements.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A rounding circuit for performing rounding of a 2's complement number, comprising:
an input for receiving the 2's complement number to be rounded, the 2's complement number having a format SXY, where S represents a sign bit, X represents one or more bits to round and keep, and Y represents one or more bits to be discarded;
first logic for adding a rounding bias to the 2's complement number;
second logic for at least one of subtracting the sign bit S from the 2's complement number, or adding the inverted sign bit !S to the 2's complement number; and
third logic for truncating Y bits from a result produced by the first and second logic to produce a rounded 2's complement number having a format SX.

2. The rounding circuit of claim 1, wherein the first logic and second logic operate on the 2's complement number in that order.

3. The rounding circuit of claim 1, wherein the second logic and first logic operate on the 2's complement number in that order.

4. The rounding circuit of claim 1, wherein the first logic comprises an adder circuit.

5. The rounding circuit of claim 4, wherein the second logic comprises a subtractor circuit.

6. The rounding circuit of claim 4, wherein the second logic circuit comprises an adder circuit with a negative input.

7. The rounding circuit of claim 1, wherein the first and second logic are embodied within an adder circuit having at least three inputs.

8. The rounding circuit of claim 4, wherein the second logic comprises an inverter circuit for inverting the sign bit S and an adder circuit for adding the inverted sign bit !S to the 2's complement number.

9. The rounding circuit of claim 1, wherein the first and second logic are embodied in an adder circuit having at least three inputs or an adder circuit having at least two inputs and a carry-in bit, and an inverter circuit.

10. The rounding circuit of claim 1, wherein the first logic comprises an adder circuit having a first input representing the input for receiving the 2's complement number, and a second input for receiving the rounding bias; the second logic comprises a subtractor circuit having a third input for receiving the output of the adder circuit, and a fourth input for receiving the sign bit; and the third logic receives at a fifth input the output of the subtractor circuit.

11. The rounding circuit of claim 1, wherein the first logic comprises an adder circuit having a first input representing the input for receiving the 2's complement number, and a second input for receiving the rounding bias; the second logic comprises another adder circuit having a third input for receiving the output of the adder circuit, and a fourth input for receiving the sign bit, the fourth input being a negative input; and the third logic receives at a fifth input the output of the another adder circuit.

12. The rounding circuit of claim 1, wherein the first and second logic are embodied in an adder circuit having a first input representing the input for receiving the 2's complement number, a second input for receiving the rounding bias, and a third input for receiving the sign bit, the third input being a negative input; and the third logic receives at a fourth input the output of the adder circuit.

13. The rounding circuit of claim 1, wherein the first logic comprises an adder circuit having a first input representing the input for receiving the 2's complement number, and a second input for receiving the rounding bias; the second logic comprises another adder circuit having a third input for receiving the output of the adder circuit, and a fourth input for receiving the inverted sign bit; and the third logic receives at a fifth input the output of the another adder circuit.

14. The rounding circuit of claim 1, wherein the first and second logic are embodied in an adder circuit having a first input representing the input for receiving the 2's complement number, a second input for receiving the rounding bias, and a third input for receiving the inverted sign bit; and the third logic receives at a fourth input the output of the adder circuit.

15. An arithmetic logic unit (ALU) comprising a rounding circuit as recited in claim 1.

16. A method for performing rounding of a 2's complement number, comprising the steps of:
receiving the 2's complement number to be rounded, the 2's complement number having a format SXY, where S represents a sign bit, X represents one or more bits to round and keep, and Y represents one or more bits to be discarded;
adding a rounding bias to the 2's complement number;
at least one of subtracting the sign bit S from the 2's complement number, or adding the inverted sign bit !S to the 2's complement number; and
truncating Y bits from a result produced by the first and second logic to produce a rounded 2's complement number having a format SX.

17. The method of claim 16, wherein the adding of the rounding bias and the at least one of subtracting/adding are performed in that order.

18. The method claim 16, wherein the at least one of subtracting/adding and the adding of the rounding bias are performed in that order.
